(19) United States
(12) Patent Application Publication
(10) Pub. No.: US 2026/0220895 A1
(43) Pub. Date: Jul. 30, 2026

(54) PREDICTIVE MODELING AND VISUALIZATION OF SKIN, HAIR AND SCALP

(71) Applicant: L'Oreal, Paris (FR)

(72) Inventor: Dominic AKERELE, Brooklyn, NY (US)

(73) Assignee: L'Oreal, Paris (FR)

(21) Appl. No.: 19/040,770

(22) Filed: Jan. 29, 2025

(51) Int. Cl. G06T 19/00; G06T 17/00

(52) U.S. Cl. CPC G06T 19/00; G06T 17/00

(57) ABSTRACT

A computer system receives input health and beauty data and exposome values (e.g., a sleep value, a pollution value, a UV exposure value, a chemical exposure value, or a combination thereof) for a user; generates a predictive visualization of a skin, scalp, or hair condition based on the exposome values and health and beauty data; and outputs the predictive visualization in the form of one or more renderings of the condition on a 3D avatar. The computer system may receive at least some of the health and beauty data or exposome values from a wearable device of the user. A recommendation engine of the computer system may generate a product or care routine recommendation based on the based on the exposome values and the health and beauty data of the user, and the predictive visualization may be further based on the product or care routine recommendation.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a computer system receives input health and beauty data and exposome values for a user; generates a predictive visualization of a skin, scalp, or hair condition based on the exposome values and the health and beauty data for the user; and outputs the predictive visualization in the form of one or more renderings of the skin, scalp, or hair condition on a 3D avatar. In some embodiments, the condition is a skin condition including fine lines or wrinkles, acne, hyperpigmentation, or a combination thereof. In some embodiments, the computer system requests and receives at least some of the health and beauty data or exposome values from a wearable device of the user. In some embodiments, the exposome values comprise a sleep value, a pollution value, a UV exposure value, a chemical exposure value, or a combination thereof. In some embodiments, the exposome values comprise exposome intensity values, and the skin strain score for each of the exposome values is a product of the exposome intensity value, a weighting coefficient, a mitigation coefficient, and a personalization coefficient. In some embodiments, the mitigation coefficient is calculated at least in part on cosmetic use information in the health and beauty data. In some embodiments, generating the predictive visualization comprises processing the exposome values in an exposome algorithm to obtain a skin strain score for each of the exposome values.

In some embodiments, the method further comprises receiving image data of the user, and the generating of the predictive visualization of the skin, scalp, or hair condition is further based on the image data of the user. In some embodiments, the method further comprises, by a recommendation engine of the computer system, generating a product or care routine recommendation based on the based on the exposome values and the health and beauty data of the user. In some embodiments, the predictive visualization is further based on the product or care routine recommendation. In some embodiments, the method further includes receiving 3D sensor data for the user; and generating or modifying the 3D avatar for the user based on the 3D sensor data.

Computer-readable media having stored thereon computer-executable instructions configured to cause a computer system to perform techniques described herein are also disclosed. Corresponding computing devices and systems are also disclosed.

### BRIEF DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 is a block diagram of a system for generating a predictive visualization of a skin, scalp, or hair condition based on exposome values and health and beauty data for a user, according to various aspects of the present disclosure;

FIG. 2A is screen shot diagram of a user interface for a mobile device, according to various aspects of the present disclosure;

FIG. 2B is a diagram of a linear model architecture for calculating skin strain values, according to various aspects of the present disclosure;

FIG. 3 is a block diagram that illustrates an embodiment of a client computing device according to various aspects of the present disclosure;

FIG. 4A is a block diagram that illustrates a computer system in which various aspects of the present disclosure may be implemented;

FIG. 4B is a block diagram of a feedback system that may be implemented in the computer system of FIG. 4A for generating a predictive visualization of skin conditions according to various aspects of the present disclosure;

FIG. 5 is a flowchart that illustrates an embodiment of a method of generating a predictive visualization of a skin, scalp, or hair condition based on exposome values and health and beauty data for a user, according to various aspects of the present disclosure; and

FIG. 6 is a block diagram that illustrates aspects of an illustrative computing device appropriate for use as a computing device of the present disclosure.

### DETAILED DESCRIPTION

Described embodiments include computer system that collects beauty and health data; integrates data from external health sources and devices (e.g., health monitoring devices such as wearable devices); processes and analyzes the data to form summary health and beauty metrics; and outputs predictive beauty and health visualizations in the form of user-based 3D avatar visualizations and renderings of skin, hair, and scalp concerns as they develop in real time.

In described embodiments, visualizations represent changes over time based on inputs that are specific to the user. However, personal data privacy still can be preserved in such visualizations, because even when modelled in 3D, the visualizations need not include an identifiable person or personally identifiable information to depict measured or predicted changes over time. Indeed, an anonymized model can be used that is less distracting for the user while still providing the desired information. In an illustrative scenario, a user is on-boarded to the system (e.g., via a mobile application or web-based application) through a questionnaire assessment and one or more 3D scans (e.g., face and hair scans) to obtain a baseline model. This baseline includes skin or hair concerns suggested by the system and further verified by the user through self-diagnosis and concern tagging.

In some embodiments, data is transformed and processed through a scalable linear model that enables generation and output of predictive skin, hair, and scalp outcomes in the form of real time 3D avatar visualizations of health and beauty summary metrics and hair, scalp, and skin concerns as they develop over time. In some embodiments, the system generates a 3D avatar that renders details of skin and hair features and concerns (e.g., in the form of color-coded visualizations) that correspond to user-reported and algorithm-generated skin and hair concern tagging from the scans and/or other information. In some embodiments, visualizations are updated over time as follow-up 3D scans and concern tagging are performed. In some embodiments, updates to visualizations provide a history and/or prediction of concerns and changes or improvements. For example, visualizations can be stored and rendered as animations (which may include interpolations or morphing between visualizations rendered at different points in time) or a series of static renderings representing measured or predicted changes over time.

In some embodiments, outputs of the system include predictive 3D avatar visualization and modeling of possible skin, hair, and scalp concerns that could develop based on changes to beauty and health metrics, behavior interventions, and the use of cosmetic, skin care, or hair care products. In some embodiments, such products and possible care routine changes or interventions are recommended by the system using a machine learning approach.

In some embodiments, the system uses a linear model and neural network approach to filter, transform, and aggregate user data. The system uses different algorithms to process different types of input data and provide useful output, such as predictive visualization and care routine or product recommendations, based on the input data. Such algorithmic approaches include, in any combination, an exposome algorithm into which individual data sources can be aggregated and integrated; a beauty and health exposure algorithm that classifies and transforms input data to create scoring, visualization, reporting, and recommendation outputs; and a product recommendation algorithm that recommends products (e.g., within a particular product group or brand, or across multiple available multiple product groups/brands) based on one or more output scores (e.g., from an exposome algorithm).

In some embodiments, outputs from the system include, in any combination, summary health and beauty metrics detailing qualitative and quantitative severity and magnitude of concerns (e.g., skin concerns); a static 3D avatar rendering detailing a summary of concerns and magnitude and mapping of concern presence and location; a dynamic 3D avatar rendering that can be manipulated based on changes to user selected factors to visualize changes to beauty concerns based on selected or de-selected factors or magnitudes; and product and procedure recommendations for concern interventions and treatment.

In some embodiments, feedback loops are created based on continued passive and active data input from the user and data integrations. Once a threshold of baseline data has been reached, the system is able to provide predictive modeling of skin, hair, and scalp concern developments as the user continues to input data into the system and as the system collects passive health and beauty data from other data and data integration sources in addition to an update of summary metrics.

In some embodiments, input data to the system includes user diagnostic questionnaire and beauty concern self-assessment information and data integration from user subscribed data sources (e.g., the Apple Health application available from Apple Inc., the BreezoMeter air quality and pollution tracking application available from BreezoMeter Ltd., weather applications), geolocation data, and wearable devices, including Fitbit devices available from Google LLC, Oura Ring devices available from Oura Health Ltd., WHOOP band devices available from WHOOP, Inc., Apple Watch devices available from Apple Inc., and smartwatch devices available from Garmin Ltd.)

In some embodiments, input data further includes image capture and image processing data, including image analysis, object recognition, and fast video image analysis data.

Technical improvements obtained by described embodiments include enhanced diagnostic performance beyond traditional mobile and web camera based diagnostics; improved and more efficient application technology using data collection, integration, transformation, and analysis, with performance improvements beyond standard formula and diagnostic systems that only use point in time and singular data inputs to generate a static output (recommendation, insight, concern magnitude); predictive skin care coaching and treatment beyond traditional skin personalization services; and enhanced performance beyond standalone product formulas for the prevention and treatment of skin concerns facilitated through personalized product recommendation and skin personalization services.

In some embodiments, the system provides predictive modeling and graphical representations of skin concerns. Such models and representations can be used to predict and represent, for example, how a skin concern will develop later after taking in inputs. Such models and representations may include a percentage chance of developing a particular condition in a particular skin area, a representation of an exposome (measures of chemical/environmental exposures) and skin characteristics, which can be represented or evaluated in different ways, such as scores or an apparent skin age.

As an example, a prediction for development of a skin concern such as acne breakouts can be made based on skin condition analysis, menstrual cycle information, exposome information, and the like, and can be used to predict an increase or decrease in risk of an acne breakout. As another example, a prediction for development of a hair concern such as damaged hair, oily hair, graying hair, or the like can be made based on hair condition analysis, exposome information, and the like, and can be used to predict an increase or decrease in risk of a particular hair condition. For prediction purposes, higher weights can be given to more important factors for particular concerns, such as UV radiation exposure, chemical exposures, etc. Visualization can show presence or absence of a condition or development of a concern to form more complete picture for a user than just a dashboard of scores and correlated to an individual. For example, if a particular hair coloring technique is predicted to cause damage to hair, and a different hair coloring product is recommended as an alternative, a first predictive visualization can be used to show hair damage over time if a first product is used, and a second predictive visualization can be used to show less hair damage over time if a second, recommended product is used (e.g., in a side-by-side comparison). It will be understood that the characteristics and features described herein are only examples, and that other characteristics or features or combinations of such characteristics or features are also desirable and are within the scope of the present disclosure. In an embodiment, digital models of skin features or characteristics are generated based on captured source data using ModiFace software available from Modiface, Inc.

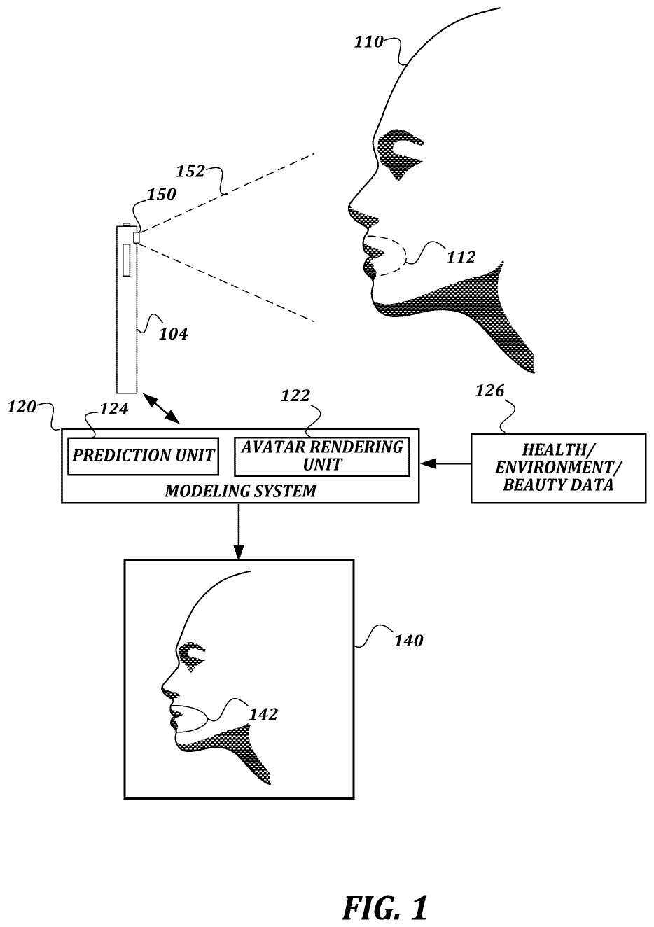

FIG. 1 is a schematic illustration of a client computing device obtaining a 3D scan of a subject, according to various aspects of the present disclosure. A sensor unit 150 of client computing device 104 captures image data and/or depth data. In this regard, sensor unit 150 includes, in some embodiments, one or more cameras (e.g., visible light cameras, IR cameras, etc.), one or more depth sensors, or a combination thereof. Cameras suitable for use in described embodiments include 2D cameras, 3D cameras. Depth sensors are used in some embodiments to obtain 3D information about surfaces and include a range of possible hardware suitable for this purpose, including RGB or infrared stereoscopic cameras, laser or infrared LiDAR sensors, and dot projectors.

In the example shown in FIG. 1, client computing device 104 is a mobile computing device such as a smartphone or tablet computer. Alternatively, other client computing devices can be used, such as a laptop or desktop computer, or a dedicated 3D scanning device.

In an embodiment, client computing device 104 communicates with modeling system 120, which is configured to generate digital avatar 140 responsive to one or more 2D or 3D digital representations of a human body feature, such as a user's face. In an embodiment, modeling system 120 is implemented in one or more remote computing devices separate from client computing device 104, as described in further detail below. Alternatively, modeling system 120 is implemented in whole or in part by client computing device 104.

In the example shown in FIG. 1, modeling system 120 includes avatar rendering unit 122, which is configured to generate digital avatar 140 based on 2D or 3D digital representations of the human body feature (e.g., a user's face or a portion thereof), and prediction unit 124, which is configured to predict changes in body feature conditions (e.g., skin conditions) responsive to one or more inputs. In an embodiment, avatar rendering unit 122 is configured to receive prediction data from prediction unit 124 and modify a texture, a geometric shape, a surface area, a volume, a pixel dimension, a voxel dimension of the digital avatar responsive to the prediction data that corresponds to a predicted change in condition of the user's body feature. Any changes in condition (whether actual or predicted) can be represented as changes in color, texture, or other features of the avatar.

In some embodiments, modeling system 120 uses a linear model and neural network approach to filter, transform, and aggregate data from different data sources, such as health and beauty data obtained from a database, wearable device, etc., and input provided by the user. In some embodiments, modeling system 120 uses different algorithms to process different types of input data and provide output, such as visualizations and recommendations, based on the input data. Such algorithmic approaches include, in any combination, an exposome algorithm into which individual data sources can be aggregated and integrated; a beauty and health exposure algorithm that classifies and transforms input data to create scoring, visualization, reporting, and recommendation outputs; and a product recommendation algorithm that recommends products (e.g., within a particular product group or brand, or across multiple available multiple product groups/brands) based on one or more output scores (e.g., from an exposome algorithm).

In the example shown in FIG. 1, region of interest 112 includes the mouth of the subject. In some embodiments, modeling system 120 is configured to generate or modify digital avatar 140 (e.g., by avatar rendering unit 122) responsive to one or more inputs indicative of an actual detected change or a predicted change to the mouth area of digital avatar 140 (e.g., a predicted acne breakout or increase in visible fine lines around the mouth based on prediction data provided by prediction unit 124).

In some embodiments, inputs to the modeling system include health/environment/beauty data 126. In an illustrative scenario, health/environment/beauty data 126 includes health information such as current skin care or cosmetic products being used, UV exposure data, weather data, pollution data, exposome data, a current or future menstrual cycle stage, or combinations thereof.

Prediction unit 124 may use different machine learning approaches to predict outcomes for different conditions, such as skin concerns. In some embodiments, prediction unit 124 uses a supervised learning approach (e.g., using artificial neural networks). In an illustrative scenario, an artificial neural network in prediction unit 124 is trained using training data of various users (e.g., health data, menstrual cycle data, image data, cosmetic data, user questionnaire data) that are labeled with corresponding skin condition information (e.g., an indication of whether an acne breakout occurred, an indication of whether skin has become oily or dry, an indication of whether visibility of fine lines has increased). In an illustrative operation, a trained neural network in prediction unit 124 takes image data and health/environment/beauty data 126 as input and generates skin condition prediction data as output. Alternatively, the input data is transformed and processed through a scalable linear model that enables generation of predictive skin, hair, and scalp outcomes. As further alternatives, prediction unit 124 can use an unsupervised learning or reinforcement learning approach.

In any prediction approach described herein, prediction data can be used to generate real time 2D or 3D avatar visualizations of health and beauty summary metrics and hair, scalp, and skin concerns as they develop over time. For example, a predicted acne breakout at a predicted location (e.g., region of interest 112) can be rendered by avatar rendering unit 122 by modifying color, shape, and/or texture data in the mouth area of digital avatar 140 based on prediction data generated by prediction unit 124. Such data may be modified on a surface of the avatar itself, or such data may provided as an opaque or semitransparent overlay in a location corresponding to the predicted condition. Further indications of conditions also can be used, such as displayed outline 142 or other graphical indicator of a region of interest in which a change in condition is detected or predicted.

As shown in FIG. 1, sensor unit 150 is integrated in client computing device 104 and is positioned and configured to capture video or still images of region of interest 112 within field of view 152. Alternatively, sensor unit 150 is external to client computing device 104. For example, one or more external 3D scanners or digital cameras in communication with a computing device may be used, or image information is captured in some other way.

In various embodiments, sensor unit 150 includes one or more visible light cameras, infrared cameras, or depth sensors, such as LiDAR sensors or TrueDepth cameras available from Apple Inc. In some embodiments, sensor unit 150 includes multiple cameras, such as for stereoscopic video capture and/or depth sensing. In some embodiments, sensor unit 150 includes one or more sensors other than cameras (e.g., a LiDAR sensor or infrared dot projector for depth sensing, a proximity sensor, etc.). In some embodiments, an infrared dot projector projects infrared dots onto a surface, and reflections from the surface are measured by an infrared camera to determine the distance each dot is from the projector system. When working in conjunction with a 3D camera, depth measurements can be mapped onto a captured 3D image. This approach is used in some embodiments to generate a 3D avatar of a body surface. In some embodiments, sensor unit 150 remains in a stationary position, while a user turns her head to allow sensor unit 150 to capture images or video of body surface 110 from different angles. In other embodiments, sensor unit 150 is moved manually or automatically to allow sensor unit 150 to capture images or video of body surface 110 from different angles while the user's head remains stationary. In some embodiments where sensor unit 150 is moved manually, the user is provided with feedback to guide the user through the scanning process, such by audible or visible cues to guide the user to move her head or the camera in a particular pattern to assist in obtaining accurate scans.

In some embodiments, modeling system 120 obtains point-cloud data during a 3D scan process. In some embodiments, modeling system 120 performs further processing on the 3D scan, such as filtering out erroneous or noisy point-cloud data.

In some embodiments, modeling system 120 includes object/feature identification software that uses face recognition or object recognition techniques, such as those in the ARKit platform available from Apple Inc., to identify features in the 3D scan. In an illustrative scenario, the software identifies a subject's nose, lips, eyes, ears, or other facial features using object recognition techniques. Described embodiments are capable of implementation in many possible ways to identify features using computer vision techniques, including matching detected edges or contours, color/pixel values, depth information, or the like in different combinations, and at particular threshold levels of confidence, any of which may be adjusted based on lighting conditions, user preferences, system design constraints, or other factors.

In some embodiments, modeling system 120 also provides 3D scan data to avatar rendering unit 122, which generates a digital 3D avatar. In some embodiments, modeling system 120 converts point-cloud data into a 3D mesh file. In some embodiments, the 3D mesh file includes color information, e.g., for color-based feature identification or to allow the system to include color information in a resulting 3D avatar. In still further embodiments, texture information is captured during scanning, a 3D mesh file with color and texture information is generated, such as in a VRML file or OBJ file. Alternatively, avatar rendering unit 122 generates a digital 3D avatar other than a 3D mesh, such as a solid model.

In some embodiments, a digital 3D avatar is used to map skin features (e.g., wrinkles, blemishes, visible pores, areas of hyperpigmentation, etc.). Mapping of skin features is useful, for example, to identify changes in skin conditions (e.g., changes in moles, skin pigmentation, skin texture, etc.), which can be helpful in diagnosis of dermatological conditions or for tracking progress of a skin care regimen to improve skin tone, reduce blemishes or acne lesions, minimize the appearance of wrinkles, or for other purposes.

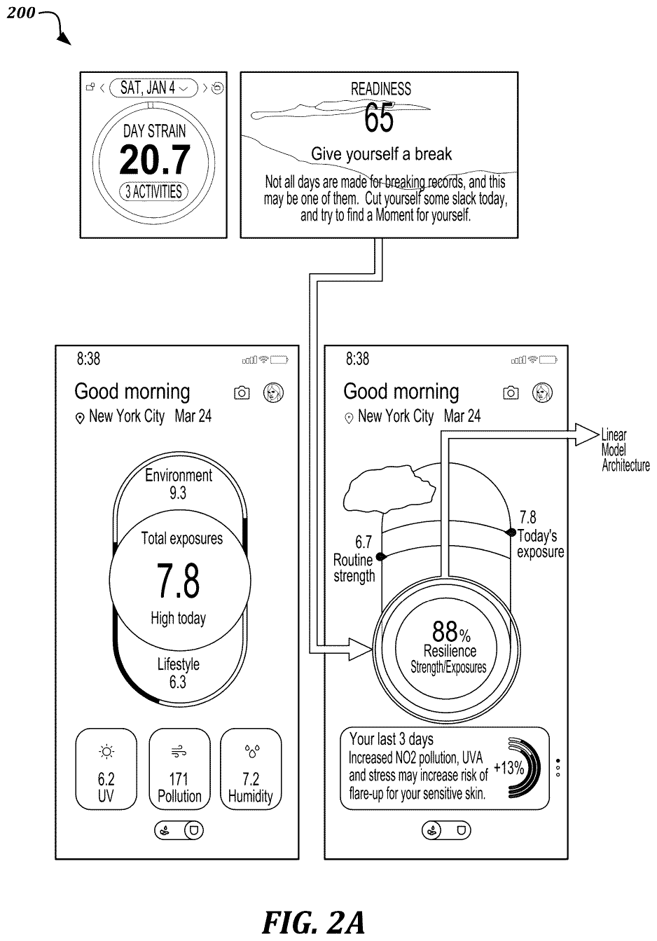

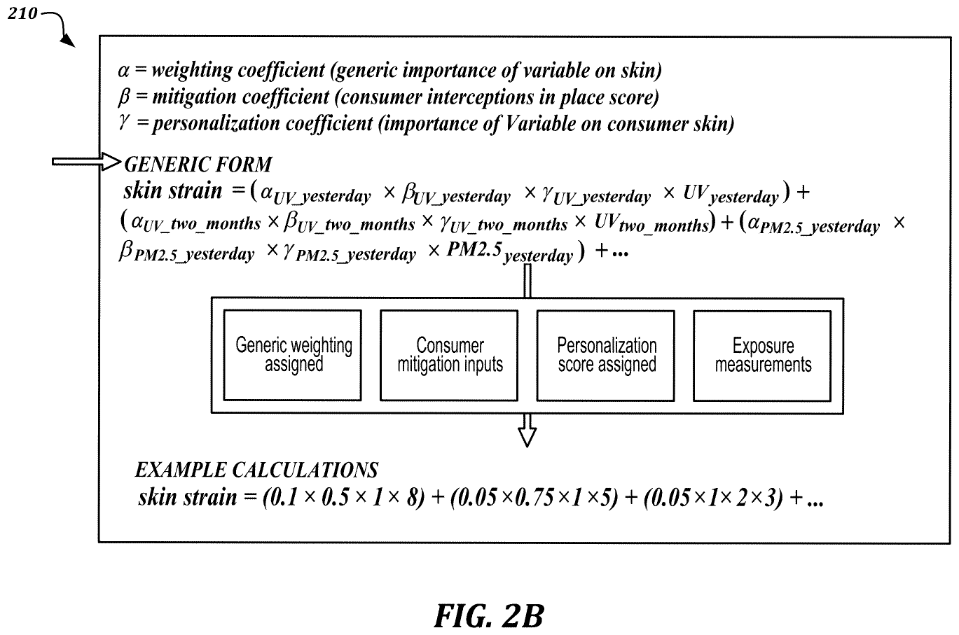

FIG. 2A is a screen shot diagram of an illustrative mobile device user interface 200 for monitoring exposome information and skin concern/strain information. As shown in FIG. 2A, user interface 200 includes displays of information relating to a skin strain score, a readiness score, exposome scores (including an environment exposure score, a lifestyle exposure score, and a total exposure score, as well as component scores such as UV exposure, pollution, and humidity. User interface 200 also includes a routine strength score, and a comparison of the routine to the total exposure level. In this example, the comparison is provided as a percentage score that is labeled as resilience, with the routine strength score being calculated as 88% of the total exposure score. User interface 200 also includes a graphical indicator of increases in exposure (including increased NO₂ pollution) and related skin concerns. As shown in FIG. 2A, in some embodiments, a skin scoring algorithm uses a linear model architecture to score one or more features of a user's skin. In an illustrative approach, a skin scoring algorithm scores a skin strain level according to the following equation for exposome variables 1 through n:
Skin_strain=(exposome_intensity₁*weighting_coefficient₁*mitigation_coefficient1* personalization_coefficient1)+ . . .+*(exposome_intensityₙ*weighting_coefficientₙ* mitigation_coefficientₙ*personalization_coefficientₙ)
Where:
   exposome_intensity=absolute intensity of exposure over chosen time interval (which can be standardized across each different exposome variable);
   weighting_coefficient=weight applied to exposome variable in proportion to how negatively impactful the exposome variable is to the skin;
   mitigation_coefficient=weight applied to decrease the impact of the exposome variable on the skin when cosmetics are applied; the weight is itself an equation taking into account the cosmetics applied and outputting the magnitude to which those cosmetics mitigate the exposome variable;
personalization_coefficient=weight applied to exposome variable to increase or decrease the impact of the exposome variable on the skin depending on the individuals specific skin concern severities and skin profile attributes; the weight is itself an equation taking into account the specific skin concern severities and skin profile attributes and outputting the magnitude to which their skin modulates the effect of exposome intensity.

FIG. 2B is a diagram of an illustrative linear model architecture 210 that is used to account for exposome variables including UV exposure, and pollution (particulate matter (PM2.5)) exposure. As shown, architecture 210 is incorporated in a model that assigns weighting coefficients, consumer mitigation coefficients (e.g., applied cosmetics or skin care products), and personalization coefficients to particular exposome variables, which are then multiplied together along with exposure measurements and combined in a total skin strain score that accounts for multiple exposome variables.

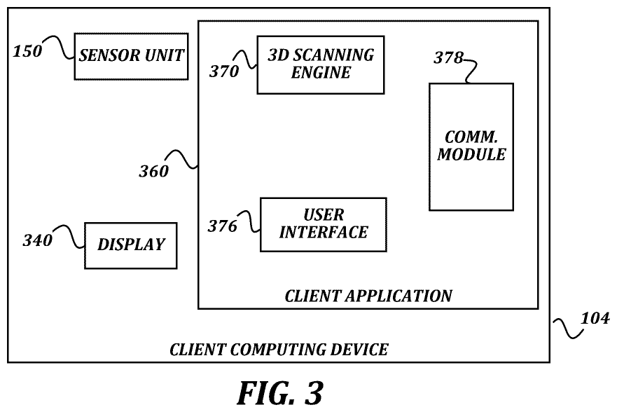

FIG. 3 is a block diagram that illustrates an embodiment of client computing device 104 according to various aspects of the present disclosure. In the example shown in FIG. 3, client computing device 104 includes sensor unit 150 and client application 360, which includes user interface 376. In some embodiments, user interface 376 includes user input elements, interactive functionality such as graphical guides to assist a user in positioning the sensor unit 150 correctly, an avatar viewer for viewing predictive visualizations, tutorial videos or animations, or other elements. Visual elements of user interface 376 are presented on display 340, such as a touchscreen display.

In some embodiments, the client application 360 also includes an image capture/3D scanning engine 370 configured to capture and process digital images (e.g., color images, infrared images, depth images, etc.) obtained from sensor unit 150. In an embodiment, such images are used to obtain a 3D mapping of the target body surface (e.g., a face). In some embodiments, the digital images or scans are processed by client computing device 104 and/or transmitted to a remote computer system for processing in modeling system 120.

In some embodiments, digital 3D avatars described herein are generated based on sensor data obtained by client computing device 104 via sensor unit 150. The digital 3D avatars are generated by client computing device 104 or by some other computing device, such as a remote cloud computing system, or a combination thereof. In some embodiments, digital 3D avatars include 3D topology and texture information, which can be used for reproducing an accurate representation of a body surface, such as facial structure and skin, hair, and/or scalp features.

Communication module 378 of client application 360 is used to prepare information for transmission to, or to receive and interpret information from other devices or systems, such as a remote computer system. Such information may include captured digital images, scans, or video, feature identification information, device settings, user preferences, user identifiers, device identifiers, or the like.

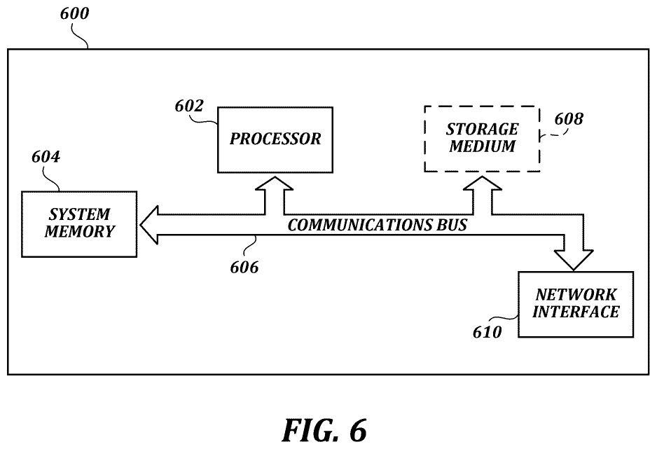

Other features of client computing devices are not shown in FIG. 3 for ease of illustration. Alternatively, client computing device 104 includes different components or circuitry, or the components and circuitry described with reference to FIG. 3 are implemented in some other way. Further description of illustrative computing devices is provided below with reference to FIG. 6.

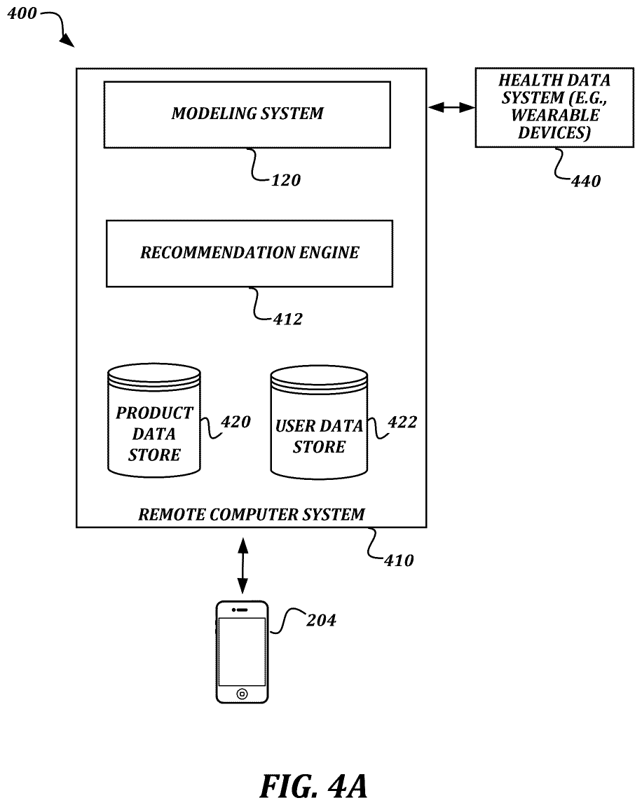

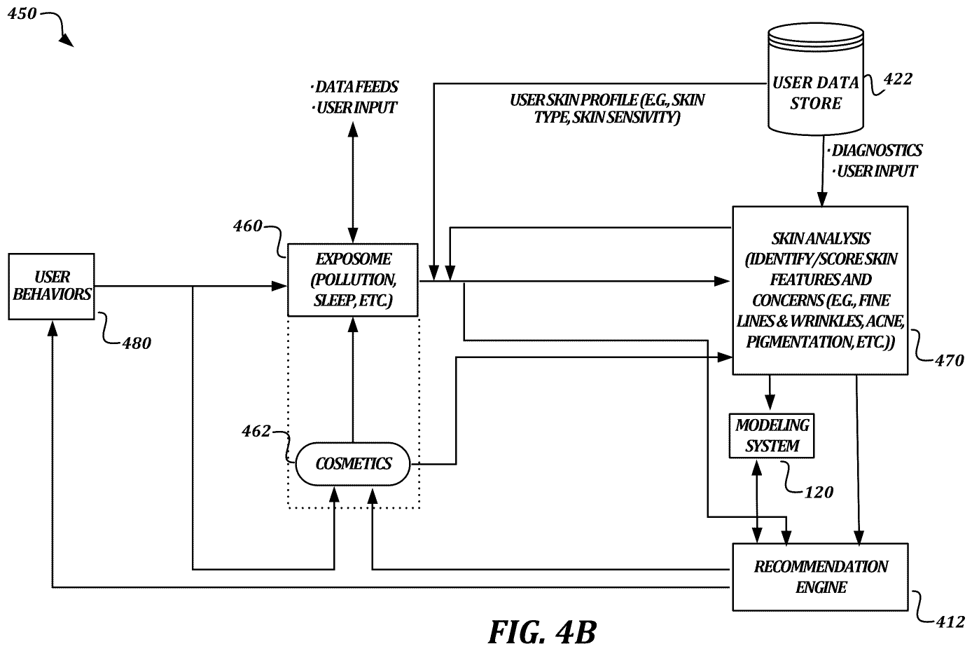

FIG. 4A is a block diagram that illustrates a system in which various aspects of the present disclosure may be implemented. Client computing device 104 connects to and communicates with remote computer system 410. In some embodiments, client computing device 104 captures data representative of body surfaces, such as point cloud data, and transmits this data to remote computer system 410 for further processing or storage. Client computing device 104 may be used by a consumer, personal care professional, or some other entity to interact with other components of system 400.

Illustrative components and functionality of remote computer system 410 will now be described. Remote computer system 410 includes one or more computers (e.g., server computers) that implement one or more of the illustrated components, e.g., in a cloud computing arrangement. As illustrated in FIG. 4A, the components implemented by remote computer system 410 include modeling system 120, recommendation engine 412, product data store 420, and user data store 422.

In some embodiments, modeling system 120 processes data obtained during a capture phase (e.g., point cloud data, color image data, infrared image data, and/or depth data) and identifies features of a body surface to be modeled. In some embodiments, modeling system 120 employs machine learning or artificial intelligence techniques (e.g., template matching, feature extraction and matching, classification, artificial neural networks, deep learning architectures, genetic algorithms, or the like) to identify features. For example, modeling system 120 may analyze data obtained during the capture phase such as point cloud data, color data, depth data, or the like to identify facial structures, pigmentation, skin texture, etc., of the user's skin.

In some embodiments, modeling system 120 uses feature identification information and the data obtained during the capture phase to generate a 3D avatar of a body surface or other object. In some embodiments, data obtained during the capture phase and feature identification information is associated with a user and stored the user data store 422. User consent is obtained prior to storing any information that is private to a user or can be used to identify a user.

In some embodiments, recommendation engine 412 generates product or care routine recommendations, which can be transmitted to, e.g., client computing device 104. In an embodiment, recommendation engine 412 generates a recommendation based on information received from product data store 420 along with user information from user data store 422, client computing device 104, or a combination thereof, or from some other source or combination of sources. In an embodiment, recommendation engine 412 receives a request for a new or updated recommendation from client computing device 104, obtains information from product data store 420 (e.g., available cosmetics, skin care products, applicators, etc.), user data store 422 (e.g., users'answers to questions about themselves, health data, location, age, products used, etc.), client computing device 104 (e.g., information describing the user's current location, device usage data, etc.), and/or health data system 440 (e.g., wearable health monitoring devices, health records, etc.) and uses this information to generate recommendations.

In some embodiments, modeling system 120 includes one or more modules depicted in FIG. 1, such as prediction unit 124 or avatar rendering unit 122.

FIG. 4B is a block diagram that illustrates a feedback system which can be used in various aspects of the present disclosure, with reference to illustrative components and functionality of remote computer system 410. For example, feedback system 450 may be implemented in the computer system of FIG. 4A for generating a predictive visualization of skin conditions according to various aspects of the present disclosure.

As illustrated in FIG. 4B, components involved in feedback system 450 include modeling system 120, recommendation engine 412, and user data store 422. In this example, user data store 422 provides information such as a user skin profile (e.g., skin type, skin sensitivity), diagnostic information, and potentially other types of user information such as questionnaire information or other user input to skin analysis unit 470 to identify skin features or concerns and calculate corresponding scores. In some embodiments, user data store 422 includes digital models of skin features or characteristics generated using ModiFace software available from ModiFace, Inc. Data from user data store 422 can be combined with other user input or periodic or non-periodic data feeds (e.g., from wearable devices), exposome data 460 and provided to skin analysis unit 470 to identify and score particular skin concerns such as fine lines, wrinkles, acne, hyperpigmentation, or the like.

In the example shown in FIG. 4B, the output of skin analysis unit 470 can be used by modeling system 120 to predict skin conditions, generate predictive visualizations skin conditions, and output the predictive visualizations in the form of one or more renderings of the skin conditions (e.g., on a 3D avatar), as described herein. In some embodiments, modeling system 120 generates the predictive visualization based at least in part on a recommendation generated by the recommendation engine 412, such as a product, lifestyle/behavior, or care routine recommendation. For example, if recommendation engine 412 generates a recommendation to apply a particular cosmetic, the cosmetic recommendation can be used by modeling system 120 to generate a predictive visualization based at least in part on the cosmetic recommendation, which may include predicting development of a skin concern over time based on an assumption that the cosmetic is applied by the user according to the recommendation.

Furthermore, predicted developments in skin conditions generated by modeling system 120 can be used by recommendation engine 412 to generate or modify recommendations, allowing such techniques to be used in combination to iterate and thereby improve predictions and recommendations. For example, if recommendation engine 412 generates a recommendation to apply a particular cosmetic, the cosmetic recommendation can be used by modeling system 120 to predict development of a skin concern over time based on an assumption that the cosmetic is applied by the user according to the recommendation. The predicted development of the skin concern can then be provided back to recommendation engine 412 to determine whether to modify the recommendation, such as in a situation where modeling system 120 indicates that a recommendation will not effectively mitigate a particular skin concern or will cause other undesirable effects.

Cosmetics 462 (e.g., from product data store 420, user data store 422, or a combination thereof) can be used to calculate mitigating or modulate effects on exposome variables, such as reduction of exposure intensities (e.g., reduction of UV exposure intensity due to users'application of cosmetics, sunscreen, or other skin care products). User behaviors 480 can be adapted to comply with cosmetics recommendations or lifestyle/behavior recommendations generated by recommendation engine 412 to protect against or intercept some exposures to reduce their severity, such as by using particular cosmetics or avoiding situations (e.g., insufficient sleep, poor diet) or locations (e.g., unshaded locations with intense sunlight, polluted cities) where exposures are expected.

Cosmetics data 462, exposome data 460, and user data (including data representative of user behaviors 480) also can be used in skin analysis unit 470 for identification and scoring of skin features or concerns. For example, cosmetics data 462 may indicate direct modulation of particular skin concerns, such as by applying foundation in an area where fine lines or wrinkles are a concern, which may be considered by skin analysis unit 470 to reduce corresponding skin concern scores. As another example, exposome data 460 may indicate conditions where particular skin concerns such as fine lines or hyperpigmentation may be intensified, such as by UV exposure.

Cosmetics data 462, exposome data 460, and user data (including data representative of user behaviors 480) also can be used in recommendation engine 412 for generating recommendations, in combination with or independent of skin concern scoring. For example, if skin analysis unit 470 provides scores that indicate UV exposure-related skin concerns such as fine lines or wrinkles are of low concern, an increase in intensity of UV exposure as indicated by exposome data 460 may still be considered by recommendation engine 412 to generate cosmetics recommendations or lifestyle/behavior recommendations to mitigate UV exposure independent of skin concern scoring.

In some embodiments, components illustrated in FIGS. 4A and 4B, including modeling system 120 and/or recommendation engine 412, employ machine learning or artificial intelligence techniques (e.g., template matching, feature extraction and matching, classification, artificial neural networks, deep learning architectures, genetic algorithms, or the like). In an embodiment, to generate a custom product recommendation or care routine or behavior recommendation, recommendation engine 412 may analyze image data, health data, user-provided data, or other data to generate or modify a recommendation that suits the particular skin features, environment, behavior, and/or preferences of the user.

Described embodiments allow for different machine learning approaches, or combinations of approaches, to be employed, using one or more machine learning models. In some embodiments, the machine learning models are neural networks, including but not limited to feedforward neural networks, convolutional neural networks (CNNs), recurrent neural networks, and generative adversarial networks (GANs). In some embodiments, any suitable training technique may be used, including but not limited to gradient descent, which may include stochastic, batch, and mini-batch gradient descent.

The devices shown in FIGS. 1, 3, and 4A, or other devices used in described embodiments may communicate with each other via a network (not shown), which may include any suitable communication technology including but not limited to wired technologies such as DSL, Ethernet, fiber optic, USB, and Firewire; wireless technologies such as WiFi, WiMAX, 3G, 4G, LTE, 5G, and Bluetooth; and the Internet. In general, communication between computing devices or components in FIGS. 1, 3, and 4A, or other components or computing devices used in accordance with described embodiments, occur directly or through intermediate components or devices.

Many alternatives to the arrangements disclosed and described with reference to FIGS. 1-4B are possible. For example, functionality described as being implemented in multiple components may instead be consolidated into a single component, or functionality described as being implemented in a single component may be implemented in multiple illustrated components, or in other components that are not shown in FIGS. 1-4B. As another example, functionality described as being performed by a particular device may instead be performed by one or more other devices within a system. As an example, recommendation engine 412 or modeling system 120 may be implemented in client computing device 104, remote computer system 410, or in some other device or combination of devices.

In addition to the technical benefits of described embodiments that are described elsewhere herein, numerous other technical benefits are achieved in some embodiments. For example, system 400 allows some aspects of the process to be conducted independently by client computing devices, while moving other processing burdens to remote computer system 410 (which may be a relatively high-powered and reliable computing system), thus improving performance and preserving battery life for functionality provided by client computing devices.

In general, the word “engine,” as used herein, refers to logic embodied in hardware or software instructions written in a programming language, such as C, C++, COBOL, JAVA™, PHP, Perl, HTML, CSS, JavaScript, VBScript, ASPX, Microsoft .NET™, and/or the like. An engine may be compiled into executable programs or written in interpreted programming languages. Software engines may be callable from other engines or from themselves. Generally, the engines described herein refer to logical modules that can be merged with other engines or divided into sub-engines. The engines can be stored in any type of computer-readable medium or computer storage device and be stored on and executed by one or more general purpose computers, thus creating a special purpose computer configured to provide the engine or the functionality thereof.

As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, as described further below. One of ordinary skill in the art will recognize that separate data stores described herein may be combined into a single data store, and/or a single data store described herein may be separated into multiple data stores, without departing from the scope of the present disclosure.

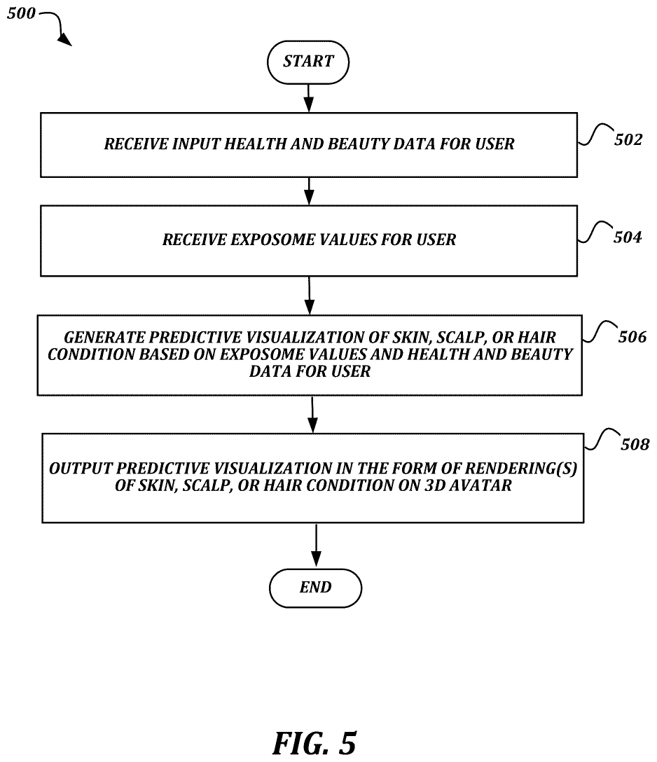

FIG. 5 is a flowchart that illustrates an embodiment of a method of generating a predictive visualization of a skin, scalp, or hair condition based on exposome values and health and beauty data for a user. In the example shown in FIG. 5, method 500 is performed by a computer system including one or more computing devices, such as remote computer system 410 or some other computing device or combination of devices.

At block 502, a computer system receiving input health and beauty data for a user, and at block 504, the computer system receives exposome values for the user. In some embodiments, the computer system requests and receives at least some of the health and beauty data or exposome values from a wearable device of the user. In some embodiments, the exposome values comprise a sleep value, a pollution value, a UV exposure value, a chemical exposure value, or a combination thereof. In some embodiments, the exposome values comprise exposome intensity values, and the skin strain score for each of the exposome values is a product of the exposome intensity value, a weighting coefficient, a mitigation coefficient, and a personalization coefficient. In some embodiments, the mitigation coefficient is calculated at least in part on cosmetic use information in the health and beauty data.

At block 506, the computer system generates a predictive visualization of a skin, scalp, or hair condition based on the exposome values and the health and beauty data for the user. In some embodiments, generating the predictive visualization comprises processing the exposome values in an exposome algorithm to obtain a skin strain score for each of the exposome values. At block 508, the computer system outputs the predictive visualization in the form of one or more renderings of the skin, scalp, or hair condition on a 3D avatar.

In some embodiments, the method further comprises receiving image data of the user, and the generating of the predictive visualization of the skin, scalp, or hair condition is further based on the image data of the user. In some embodiments, the method further comprises, by a recommendation engine of the computer system, generating a product or care routine recommendation based on the based on the exposome values and the health and beauty data of the user. In some embodiments, the predictive visualization is further based on the product or care routine recommendation. In some embodiments, the method further includes receiving 3D sensor data for the user; and generating or modifying the 3D avatar for the user based on the 3D sensor data.

Many alternatives to the process depicted in FIG. 5 are possible, in accordance with embodiments described herein. For example, in some embodiments the process of obtaining a 3D scan is adapted based on identified features, as described above. As another example, techniques and devices described herein are capable of being used to generate models of objects or surfaces other than human body surfaces.

FIG. 6 is a block diagram that illustrates aspects of an exemplary computing device 600 appropriate for use as a computing device of the present disclosure. While multiple different types of computing devices were discussed above, the exemplary computing device 600 describes various elements that are common to many different types of computing devices. While FIG. 6 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 600 may be any one of any number of currently available or yet to be developed devices.

In its most basic configuration, the computing device 600 includes at least one processor 602 and a system memory 604 connected by a communication bus 606. Depending on the exact configuration and type of device, the system memory 604 may be volatile or nonvolatile memory, such as read only memory (“ROM”), random access memory (“RAM”), EEPROM, flash memory, or similar memory technology. Those of ordinary skill in the art and others will recognize that system memory 604 typically stores data and/or program modules that are immediately accessible to and/or currently being operated on by the processor 602. In this regard, the processor 602 may serve as a computational center of the computing device 600 by supporting the execution of instructions.

As further illustrated in FIG. 6, the computing device 600 may include a network interface 610 comprising one or more components for communicating with other devices over a network. Embodiments of the present disclosure may access basic services that utilize the network interface 610 to perform communications using common network protocols. The network interface 610 may also include a wireless network interface configured to communicate via one or more wireless communication protocols, such as WiFi, 2G, 3G, LTE, WiMAX, Bluetooth, Bluetooth low energy, and/or the like. As will be appreciated by one of ordinary skill in the art, the network interface 610 illustrated in FIG. 6 may represent one or more wireless interfaces or physical communication interfaces.

In the exemplary embodiment depicted in FIG. 6, the computing device 600 also includes a storage medium 608. However, services may be accessed using a computing device that does not include means for persisting data to a local storage medium. Therefore, the storage medium 608 depicted in FIG. 6 is represented with a dashed line to indicate that the storage medium 608 is optional. In any event, the storage medium 608 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 604 and storage medium 608 depicted in FIG. 6 are merely examples of computer-readable media.

Suitable implementations of computing devices that include a processor 602, system memory 604, communication bus 606, storage medium 608, and network interface 610 are known and commercially available. For ease of illustration and because it is not important for an understanding of the claimed subject matter, FIG. 6 does not show some of the typical components of many computing devices. In this regard, the computing device 600 may include input devices, such as a keyboard, keypad, mouse, microphone, touch input device, touch screen, and/or the like. Such input devices may be coupled to the computing device 600 by wired or wireless connections including RF, infrared, serial, parallel, Bluetooth, Bluetooth low energy, USB, or other suitable connections protocols using wireless or physical connections. Similarly, the computing device 600 may also include output devices such as a display, speakers, printer, etc. Since these devices are well known in the art, they are not illustrated or described further herein.

While illustrative embodiments have been illustrated and described, it will be appreciated that various changes can be made therein without departing from the spirit and scope of the invention.

1. A method performed by a computer system including one or more computing devices, the method comprising:
receiving input health and beauty data for a user;
receiving exposome values for the user;
generating a predictive visualization of a skin, scalp, or hair condition based on the exposome values and the health and beauty data for the user;
outputting the predictive visualization in the form of one or more renderings of the skin, scalp, or hair condition on a 3D avatar.

2. The method of claim 1 wherein generating the predictive visualization comprises processing the exposome values in an exposome algorithm to obtain a skin strain score for each of the exposome values, and wherein the exposome values comprise a sleep value, a pollution value, a UV exposure value, a chemical exposure value, or a combination thereof.

3. The method of claim 2 wherein the exposome values comprise exposome intensity values, and wherein the skin strain score for each of the exposome values is a product of the exposome intensity value, a weighting coefficient, a mitigation coefficient, and a personalization coefficient.

4. The method of claim 3 wherein mitigation coefficient is calculated at least in part on cosmetic use information in the health and beauty data.

5. The method of claim 1 further comprising receiving image data of the user, wherein the generating of the predictive visualization of the skin, scalp, or hair condition is further based on the image data of the user.

6. The method of claim 1 wherein the computer system requests and receives at least some of the health and beauty data from a wearable device of the user.

7. The method of claim 1 wherein the computer system requests and receives at least some of the exposome values from a wearable device of the user.

8. The method of claim 1 further comprising, by a recommendation engine of the computer system, generating a product or care routine recommendation based on the based on the exposome values and the health and beauty data of the user, and wherein the predictive visualization is further based on the product or care routine recommendation.

9. The method of claim 1 wherein the skin, scalp, or hair condition comprises a skin condition including fine lines or wrinkles, acne, pigmentation, or a combination thereof.

10. The method of claim 1 further comprising receiving 3D sensor data for the user; and generating or modifying the 3D avatar for the user based on the 3D sensor data.

11. A non-transitory computer-readable medium having stored thereon computer-executable instructions configured to cause a computer system to perform steps comprising:
receiving input health and beauty data for a user;
receiving exposome values for the user;
generating a predictive visualization of a skin, scalp, or hair condition based on the exposome values and the health and beauty data for the user;
outputting the predictive visualization in the form of one or more renderings of the skin, scalp, or hair condition on a 3D avatar.

12. The non-transitory computer-readable medium of claim 11 wherein generating the predictive visualization comprises processing the exposome values in an exposome algorithm to obtain a skin strain score for each of the exposome values, and wherein the exposome values comprise a sleep value, a pollution value, a UV exposure value, a chemical exposure value, or a combination thereof.

13. The non-transitory computer-readable medium of claim 12 wherein the exposome values comprise exposome intensity values, and wherein the skin strain score for each of the exposome values is a product of the exposome intensity value, a weighting coefficient, a mitigation coefficient, and a personalization coefficient.

14. The non-transitory computer-readable medium of claim 13 wherein mitigation coefficient is calculated at least in part on cosmetic use information in the health and beauty data.

15. The non-transitory computer-readable medium of claim 11, the steps further comprising receiving image data of the user, wherein the generating of the predictive visualization of the skin, scalp, or hair condition is further based on the image data of the user.

16. The non-transitory computer-readable medium of claim 11 wherein the computer system requests and receives at least some of the health and beauty data from a wearable device of the user.

17. The non-transitory computer-readable medium of claim 11 wherein the computer system requests and receives at least some of the exposome values from a wearable device of the user.

18. The non-transitory computer-readable medium of claim 11, the steps further comprising, by a recommendation engine of the computer system, generating a product or care routine recommendation based on the based on the exposome values and the health and beauty data of the user, and wherein the predictive visualization is further based on the product or care routine recommendation.

19. The non-transitory computer-readable medium of claim 11 wherein the skin, scalp, or hair condition comprises a skin condition including fine lines or wrinkles, acne, pigmentation, or a combination thereof.

20. The non-transitory computer-readable medium of claim 11, the steps further comprising receiving 3D sensor data for the user; and generating or modifying the 3D avatar for the user based on the 3D sensor data.
